(19) United States
(12) Patent Application Publication
(10) Pub. No.: US 2004/0109161 A1
(43) Pub. Date: Jun. 10, 2004

(54) Method and system for processing color-measurement data

(76) Inventors: John E. Stranzl JR., Chapel Hill, NC (US); Mark D. Bowers, Raleigh, NC (US)

Correspondence Address: CUMMINGS & LOCKWOOD, Four Stamford Plaza, P.O. Box 120, Stamford, CT, 06904-0120, US

(21) Appl. No.: 10/314,095

(22) Filed: Dec. 6, 2002

(51) Int. Cl. G01J 3/46

(52) U.S. Cl. 356/425

(57) ABSTRACT

A method and a system for processing color-measurement data are disclosed. The method and system include detection of a predetermined characteristic in a data stream originating from or sent to a remote color-measuring instrument, use of the predetermined characteristic to locate color-measurement data in the data stream, and interception of the color-measurement data. The intercepted color-measurement data may be advantageously processed, e.g., by profiling or the like.

### BACKGROUND

1. Technical Field

The present disclosure is directed to color measurement technology and, more particularly, to methods and systems for processing color-measurement data that facilitates, inter alia, improved agreement between color-measuring instruments.

2. Background Art

Color-measuring instruments, such as spectrophotometers and colorimeters, are generally employed in measuring an article's color properties. In particular color-measurement implementations, spectrophotometers and calorimeters are advantageously used in determining whether the color of an article meets applicable color specifications. In addition, color-measuring instruments are useful in coordinating and/or checking color measurements at multiple locations and/or production sites. For example, accurate and standardized color measurement is critical when different manufacturers, or the same manufacturer at several different locations, undertake to produce parts of the same color, e.g., parts that are intended to match when assembled. Color matching is also important, for example, in production of replacement parts.

The performance of color-measuring devices generally varies from instrument to instrument. These variations occur for several reasons. First, the performance of similar devices may vary greatly from manufacturer to manufacturer (i.e., from color-measuring instrument model to model) due to differences in design, manufacturing processes, raw materials, color measurement/profiling software, processing tolerances, and the like. For purposes of the present disclosure, color-measurement variations between different color-measuring instrument models are referred to as “intra-instrument” variations, and the degree to which different color-measuring instruments yield comparable color-measurement data is referred to as “intra-instrument agreement.”

Second, the performance of the same model of a device made by the same manufacturer may vary from unit to unit, e.g., due to manufacturing tolerances, measurement drift, and the like. For purposes of the present disclosure, color-measurement variations between different units of the same color-measuring instrument model is referred to as “inter-instrument” variations, and the degree to which different units of the same color-measuring instrument model yield comparable color-measurement data is referred to as “inter-instrument agreement.”

In assessing both intra-instrument and inter-instrument agreement, the performance of a single device or instrument may vary as it ages or is utilized under different operating conditions (e.g., based on temperature or humidity effects). These and other types of variations generally lead to a lack of assurance that color-measurement data from different color-measuring instruments, even if identical models, will result in manufactured parts that will, in fact, exhibit a color match.

An approach to resolving this problem was set forth in commonly assigned U.S. Pat. No. 6,043,894 to Van Aken et al. (“the '894 patent”), the entire disclosure of which is hereby incorporated by reference. The '894 patent provides methods for maintaining uniformity of color measurements generated by a plurality of color-measuring instruments. According to an exemplary embodiment of the '894 patent, color values of a set of master color standards are measured on a master color-measuring instrument at a master color lab. Color values of working sets of color standards are measured on the same instrument to determine calibration values, i.e., to facilitate transfer-calibration. The working sets are provided to remote locations and measured on the remote color-measuring instruments to obtain color value measurements. Measurements from the remote instruments are transmitted to a second location, e.g., a remotely located server such as the foregoing master color laboratory, and compared with the calibration values obtained from measurements of the same color standards on the master instrument, to generate profiles. These profiles are provided to the remote color labs, and are applied to measured color values obtained using the respective sets of working color standards to determine corrected color values. These values may be transmitted to the master color lab and analyzed to ensure compliance with specifications as to permissible deviations.

The methods of the '894 patent allow better control over the accuracy of the measurements obtained using various remote color-measuring instruments. In turn, this enables the users to achieve uniformity in evaluations of products being measured and/or produced at different locations. Methods for maintaining uniformity of color measurements, e.g., as described in the '894 patent, typically utilize software that facilitates the profiling of data gathered by a color-measuring instrument. The profiled data may be transmitted to a second location, e.g., a master color lab, for review and/or evaluation. The NetProfiler™ system (GretagMacbeth LLC, New Windsor, N.Y.) is a commercially available product that supports color data profiling and color-measurement data transmission.

In comparing color-measurement data, problems arise when non-uniform color measurement software is used from instrument to instrument. For example, in instances where the color measurement software associated with a first color-measuring instrument, e.g., an instrument located at a first facility, is different from the color measurement software associated with a second color-measuring instrument, e.g., an instrument located at a second facility, the color measurements are generally incompatible, i.e., cannot be effectively compared to one another. The utilization of different software systems by color-measuring instruments contributes to variabilities in both intra-instrument and inter-instrument agreement.

For the foregoing reasons, new methods and systems are needed for improving intra-instrument and inter-instrument agreement between color-measuring instruments.

### SUMMARY OF THE DISCLOSURE

The present disclosure provides methods and systems for processing color-measurement data aimed at achieving better intra- and inter-instrument agreement. The disclosed methods and systems are particularly advantageous in instances where the color measurement software for generating color-measurement data associated with one or more color-measuring instruments is incompatible with, i.e., different from, the color measurement software associated with one or more other color-measuring instruments. Exemplary methods and systems according to the present disclosure allow users to make effective color-measurement determinations despite the fact that incompatible, i.e., different, software systems are being utilized (or have been utilized) in generating color-measurement data on color-measuring instruments. Indeed, the disclosed method and system permits users to take advantage of the capabilities offered by a color management network or other form of color-measurement data comparison or evaluation system, without sacrificing prior investments in systems having incompatible/different color measurement software.

Accordingly, the subject disclosure is directed to methods and systems for processing color-measurement data. According to an exemplary embodiment of the disclosed method/system, a predetermined characteristic in a data stream originating from a color-measuring instrument is detected, the data stream containing color-measurement data. The predetermined characteristic is used to locate and/or isolate the color-measurement data in the data stream, such that the color-measurement data is advantageously intercepted for further manipulation, e.g., profiling or the like. Preferably, the color-measuring instrument is a spectrophotometer and the color-measurement data is spectral data, although it is contemplated that alternative color-measuring instrumentation and/or alternative forms of color-measurement data, e.g., calorimetric data, may be employed.

According to exemplary embodiments of the present disclosure, the predetermined characteristic used to locate and/or isolate the color measurement data may take a variety of forms. For example, the predetermined characteristic may be a specific length of a field or data string in the data stream and/or may be based upon the existence of a specific field, character or identifier in the data stream.

Interception of the color-measurement data may be achieved using one or more drivers that simulate a communication port to or through which the data stream is normally communicated. Thus, for example, an advantageous interception driver according to the present disclosure may simulate a communications resource, such as a conventional serial port (i.e., RS-232 port), USB port, a radiofrequency (RF) port, a wireless communication port, or a communications port supporting the IEEE 1394 standard (e.g., a FireWire™ port available from Apple Computer; an i.link™ port available from Sony Corporation, or a Lynx™ port available from Atari Corporation).

In an exemplary embodiment of the present disclosure, a driver is provided that establishes a “virtual serial port,” i.e., a device driver that provides an interface which appears to the color-measurement application software to be a “standard” communications port. By establishing a virtual serial port and routing color-measurement communications therethrough, other applications are able to source to or from the virtual serial port, as though the data were being processed by physical hardware, such as an UART (universal asynchronous receiver-transmitter) or modem. Alternative exemplary embodiments according to the present disclosure may utilize alternative drivers associated with data communication interface(s), which may be associated, for example, with a standard serial port interface to an operating system and/or an interface allowing software control of serial port functions.

Methods and systems according to the present disclosure may be used with and/or installed on a variety of operating systems, for example, Windows, Mac, Linux, and UNIX. If a Windows operating system is used, exemplary drivers for intercepting data communications may be advantageously implemented using the WIN32 Communications API. For alternative operating systems, appropriate communications APIs may be utilized, if desired, to implement a driver as described herein, as will be apparent to persons skilled in the art.

Exemplary methods and systems according to the present disclosure may include monitoring and/or processing of the intercepted color-measurement data. In a preferred implementation of the disclosed method/system, the intercepted color-measurement data is profiled, i.e., the color-measurement data is subjected to a profiling software application so as to adjust or modify the color-measurement data based on criteria internal to the profiling software.

According to a further exemplary embodiment of the present disclosure, methods and systems for processing color-measurement data are provided which are capable of monitoring a data stream originating from application software associated with a color-measurement system; detecting a predetermined characteristic in the data stream originating from the application software; using the predetermined characteristic to intercept color-measurement data transmitted by a color-measuring instrument; and processing the color-measurement data. In an exemplary embodiment, the predetermined characteristic originating from the application software may be a command, instruction or other communication directed to the color-measuring instrument, e.g., a “take measurement” or “take reading” command.

To provide enhanced flexibility to users, methods and systems according to the subject disclosure may advantageously include a control option, whereby a user may activate interception of the spectral data by providing or communicating a “log-on” command, and/or deactivate the interception functionality by providing or communicating a “quit” command. Similarly, enhanced flexibility may be provided according to the present disclosure by permitting users to activate/deactivate the processing of intercepted color-measurement data. Thus, for example, the user may activate/deactivate the profiling of color-measurement data intercepted according to the present disclosure.

In addition, data processing selection functionality may be provided according to the present disclosure, whereby a user may select from among alternative color data processing alternatives. Thus, for example, the disclosed method/system may advantageously provide a user with the ability to select from among a plurality of profiling software applications to be applied to intercepted color-measurement data, e.g., profiling software applications designed to profile color-measurement data based on alternative color-measurement standards.

Color-measurement data that is intercepted according to the present disclosure may be stored in local memory associated with the color-measurement application, e.g., on a hard drive or disk storage associated with the color measuring instrument. Such color-measurement data storage may include the intercepted color-measurement data before and after processing, i.e., before and after the color-measurement data is subjected to a profiling software application. Methods and systems of the subject disclosure may further facilitate the transmission of spectral data to a master color laboratory for analysis and/or validation, e.g., before or after profiling is undertaken.

User commands associated with operation and use of the data interception and/or processing functionalities of the disclosed method and system are generally logged. In an exemplary embodiment of the present disclosure, the logging of user commands is implemented by functionality associated with the driver or drivers responsible for establishing the interception functionality, e.g., the driver(s) that establish a virtual serial port, and one or more of the logged user commands may function as a trigger for intercepting color-measurement data. For example, a user command that a color-measuring instrument “take reading” may be automatically logged by programming associated with the driver, and the logging of such measurement command may trigger the interception of the resulting color-measurement data generated by the color-measuring instrument.

These and other unique features of the systems, methods and devices of the present disclosure will become more readily apparent from the drawings and/or the detailed description of exemplary embodiments provided herein.

### BRIEF DESCRIPTION OF THE DRAWINGS

So that those of ordinary skill in the art to which the subject disclosure pertains will more readily understand how to make and use the methods, systems and devices described herein, aspects of exemplary embodiments of the present disclosure will be described in detail with reference to the drawings, wherein:

FIG. 1 is a data flow diagram illustrating use of a Virtual Serial Port (VSP) with a Communications Application, such that communications data originates and terminates in Application Software;

FIG. 2 is a data flow diagram illustrating an exemplary method/system of the present disclosure, wherein data from a remote color-measuring instrument received by a Communications Application is intercepted through a Virtual Serial Port and then profiled by Application Software;

FIG. 3 is a data flow diagram illustrating another exemplary method/system of the present disclosure, wherein data from a remote color-measuring instrument received by a Communications Application is intercepted through a Virtual Serial Port, profiled by Application Software, and then transmitted to a master color laboratory; and

FIG. 4 is a diagram showing a managed network of color-measuring instruments.

### DETAILED DESCRIPTION

According to the present disclosure, color-measurement data processing methods and systems are provided, whereby intra- and inter-instrument agreement is improved between color-measuring instruments. For example, intra- and inter-instrument agreement may be improved between color-measuring instruments located at one or more remote color laboratories and/or at a master color laboratory, despite the mismatch of data processing software associated with one or more of the instruments. The methods and systems of the present disclosure allow users to bypass or overcome the incompatible software by intercepting data transmitted by a color-measuring instrument for further manipulation. The manipulation may include processing of the intercepted spectral data, e.g., by way of profiling. The processed/profiled data may optionally be transmitted to a master color lab for evaluation and/or validation.

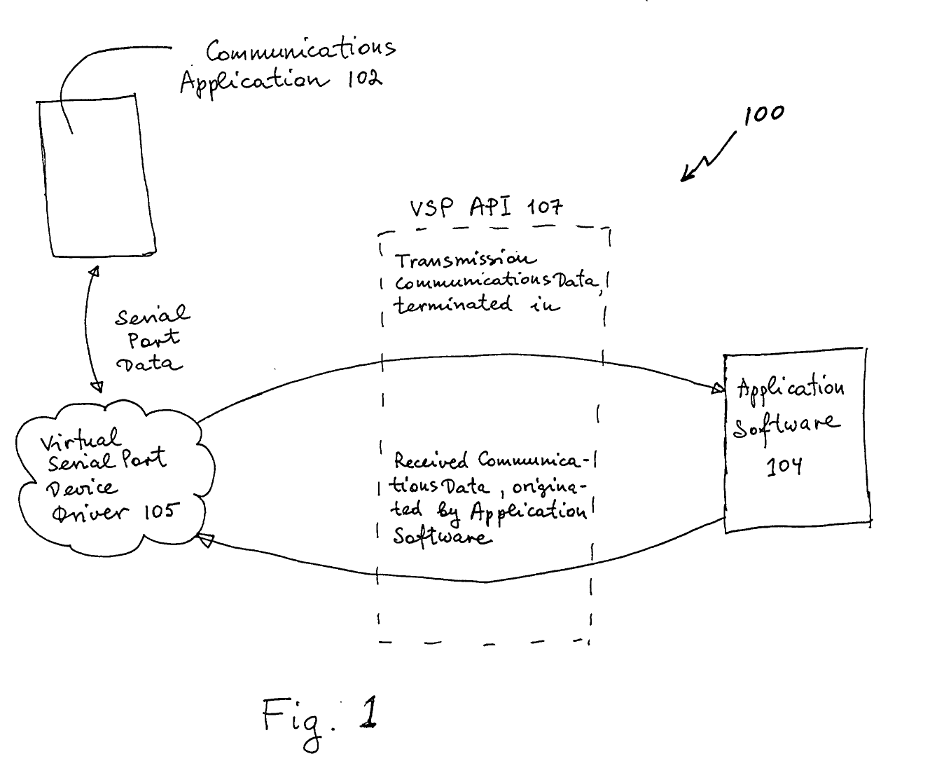

Referring now to the drawings, wherein like reference numerals identify similar features or characteristics of the methods, systems and devices disclosed herein, FIG. 1 shows a schematic illustration of an exemplary Data Communication System 100 according to the present disclosure. Communications Application 102 is typically associated with a color-measurement instrument, e.g., a spectrophotometer. Communications Application 102 may be installed and operated on a processor internal to the spectrophotometer, or a processor associated with a workstation or other computer system external to the spectrophotometer. In the latter case, the external processor generally constitutes a component of the color measurement system.

In the exemplary Data Communication System 100 of FIG. 1, color-measurement data processed, i.e., transmitted, by Communications Application 102 is typically generated using conventional color data-measurement software. Thus, the color-measuring instrument, e.g., spectrophotometer, typically generates reflectance data based on one or more sample readings. The reflectance data is converted to color-measurement data by conventional color processing software that is either internal to the color-measuring instrument or operated on an associated workstation. Color processing software for use in generating color-measurement data based on spectrophotometric readings are well known, and methods and systems according to the present disclosure may implemented regardless of the color processing software associated with the color-measuring instrument. Indeed, an advantageous aspect of the disclosed methods and systems is the flexibility embodied therein, such that color-measurement data generated by disparate color processing software can be effectively compared, processed and/or evaluated.

With further reference to FIG. 1, Communications Application 102 is generally programmed to transmit color-measurement data generated by an associated color-measuring instrument to or through one or more conventional computer ports. Communication through one or more computer ports is generally necessary to permit the color-measurement data to be transmitted to one or more peripheral components, e.g., a printer, scanner, modem, or the like. Indeed, absent computer port-based communications, the ability to electronically share and/or access the color-measurement data would be significantly inhibited, e.g., network-based communications over a LAN, WAN or the Internet would be inhibited/prevented. Communications Application 102 may also facilitate storage of the color-measurement data in appropriate computer memory, whether local or remote, by transmitting such color-measurement data through one or more computer port(s) to appropriate disk drives or remote data storage systems, e.g., a network attached storage (NAS) system.

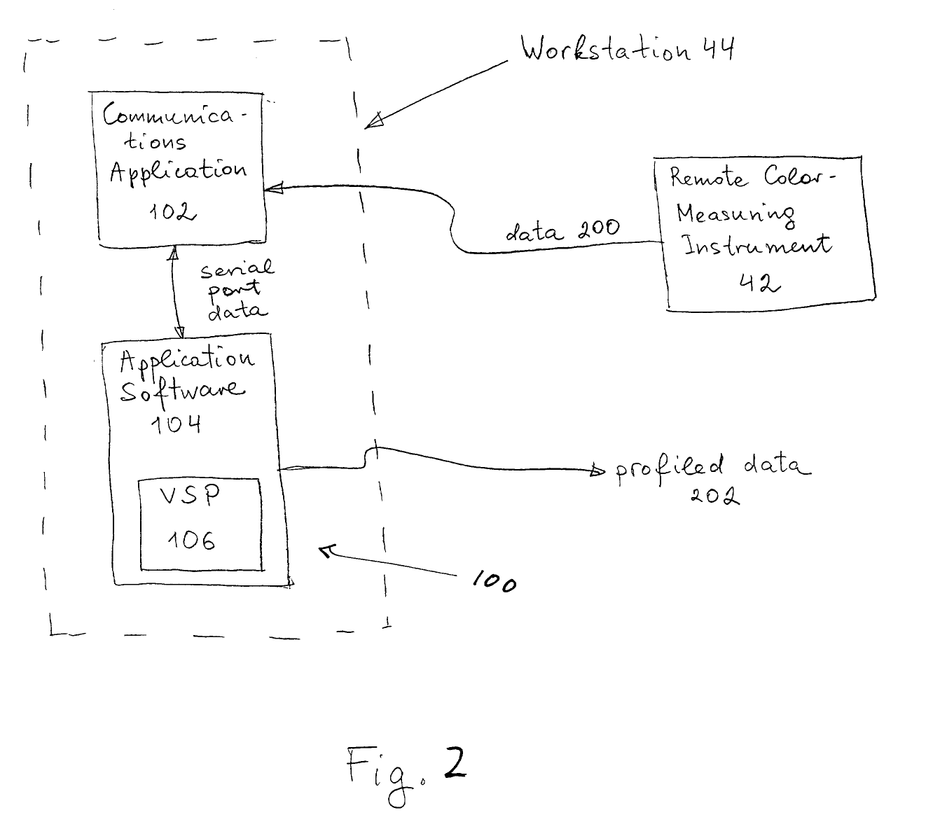

According to the present disclosure, a Device Driver 105 is advantageously provided in data communication with Applications Communication 102, such that data transmissions by Communications Application 102 are subject to potential interception by or in response to commands of Device Driver 105, as described herein. Device Driver 105 may be installed and operated on the processor associated with the color-measuring instrument or a workstation/computer system associated with, but external to, the color-measuring instrument. In an exemplary embodiment of the present disclosure scehmatically depicted in FIG. 2, Device Driver 105 establishes a “virtual serial port” such that Communications Application 102 communicates with the Virtual Serial Port (VSP) 106 in the same manner as it otherwise communicates with conventional communications resources, e.g., a conventional serial port (i.e., RS-232 port), USB port, a radiofrequency (RF) port, a wireless communication port, or a communications port supporting the IEEE 1394 standard (e.g., a FireWire™ port available from Apple Computer; an i.link™ port available from Sony Corporation, or a Lynx™ port available from Atari Corporation). Thus, for all purposes relevant to the present disclosure, VSP 106 resembles or simulates a standard communication resource.

VSP 106 generally does not include physical hardware of the type associated with conventional communication ports. Rather, Device Driver 105 and VSP 106 achieve the desired data interface functionality through a software implementation. In an exemplary embodiment, implementation of VSP 106 within Data Communication System 100 may be achieved through one or more of the following interfaces:

1. A standard serial port interface to the operating system installed on the workstation. Serial port accessories, irrespective of programming language, typically use this type of interface to access serial ports. Through such an interface, the VSP looks like any other serial port on a system.

2. An interface that allows software control of serial port functions, e.g., implemented by way of an Applications Programming Interface (API) that facilitates simulation of the hardware-oriented functions of a serial port.

According to exemplary embodiments of the present disclosure, therefore, Device Driver 105 provides an interface (i.e., VSP 106) that appears to Communications Application 102 to be a “standard” communications port. By establishing Virtual Serial Port 106 and routing color-measurement communications therethrough, other applications are able to source to or from Virtual Serial Port 106. One or more alternative drivers may be provided according to the present disclosure; such alternative driver(s) may be associated with one or more data communication interface(s), e.g., a standard serial port interface that ports to an operating system and/or an interface allowing software control of serial port functions.

Device Driver 105 and VSP 106 may be created, for example, using Virtual Serial Port and Software Development Kit products of Device Drivers International, Inc. (Cincinnati, Ohio). Alternatively, the interception of data streams within the disclosed Data Communication System 100 may be based on alternative software products and/or programming, provided such products and/or programming allow deployment of an interface that simulates a conventional communications resource, e.g., a serial port, USB ports, RF port or the like.

With further reference to Data Communication System 100, Application Software 104 is advantageously provided as part of such system. Application Software 104 may be installed and operated on a processor associated with the color-measuring instrument (e.g., a spectrophotometer) or on a processor associated with a workstation that is external to such color-measuring instrument, but involved in the color measurement methods and systems disclosed herein. Application Software 104 is generally programmed to recognize and, as desired, extract spectral data from data communications and/or transmissions that arrive from Communications Application 102 at Virtual Serial Port 106.

Data transfers to and from VSP 106 may be accessed through an appropriate interface, e.g., VSP API 107, and can therefore be controlled from and/or processed by ancillary application, such as Application Software 104. Data which would be transmitted by hardware in a physical serial port implementation may be read from the VSP Device Driver 105 using the VSP API 107. That data can be then transmitted to and processed by another component and/or software application (e.g., Application Software 104). Similarly, data which would be received by hardware in a physical serial port implementation may be written or transmitted via the VSP Device Driver 105 using the VSP API 107. Such data may originate from another component or software application, e.g., Application Software 104.

Communications Application 102, Device Driver 105, VSP 106 and Application Software 104 may be used with and/or installed on a variety of operating systems, for example, Windows, Mac, Linux, and UNIX. If a Windows operating system is used, exemplary drivers for intercepting data communications may be advantageously implemented using the WIN32 Communications API. For alternative operating systems, appropriate communications APIs may be utilized, if desired, to implement a driver as described herein, as will be apparent to persons skilled in the art. Communications between applications operating on disparate operating systems are also contemplated, with appropriate interface software as will be apparent to persons skilled in the art.

In an exemplary embodiment of the methods, systems and devices according to the present disclosure, Application Software 104 is programmed and/or configured to detect the presence of the color-measurement data in a data string received from the color-measuring instrument and to potentially intercept that data. If a spectrophotometer is used as the color-measuring instrument, the Application Software 104 may be advantageously programmed and/or configured to detect and intercept spectral data generated by such spectrophotometer.

According to an exemplary embodiment of the disclosed method/system, Application Software is programmed to recognize one or more predetermined characteristics in data stream(s) originating from a color-measuring instrument, i.e., data stream(s) transmitted by Communication Application 102 to Virtual Serial Port 106. The relevant data streams received by VSP 106 contain, inter alia, color-measurement data. A variety of predetermined characteristics may be used to locate and/or isolate color-measurement data in such data stream(s) according to the present disclosure, e.g., to differentiate color-measurement data from non-color management data. For example, the predetermined characteristic may be a specific length of a field or data string in the data stream and/or may be based upon the existence of a specific field, character or identifier in the data stream.

Once identified, the color-measurement data may be advantageously intercepted for further manipulation, e.g., profiling or the like. Exemplary methods and systems may involve monitoring and/or processing of the intercepted color-measurement data by Application Software 104. In a preferred implementation of the disclosed method/system, Application Software 104 includes profiling software that may be used to profile the intercepted color-measurement data, i.e., the color-measurement data is subjected to a profiling software application so as to adjust or modify the color-measurement data based on criteria internal to the profiling software.

One or more profiling software applications may be included within Application Software 104, and the user may select which profiling software application to employ for specific intercepted color-measurement data. The profiling software included within Application Software 104 may be generic profiling software, e.g., include non-dynamic profiling algorithms that are installed and remain unchanged until replaced or overwritten. Alternatively, Application Software 104 may be included in a network such that updated profiling software applications are transmitted on a periodic basis for use by Application Software 104 in processing intercepted color-measurement data. An exemplary networked embodiment of the present disclosure is described in greater detail below.

In the foregoing descriptions of exemplary embodiments of the present disclosure, Application Software 104 monitored and identified color-measurement data based on predetermined characteristics contained in the data stream(s) originating from Communications Application 102. According to an alternative exemplary embodiment of the present disclosure, data stream(s) originating from application software associated with a color-measurement system are monitored, e.g., commands directed to the color-measuring instrument from a keyboard or other input means associated (directly or indirectly) with the color-measuring instrument.

In this exemplary embodiment, commands originating from the keyboard (or another ancillary command source) are directed through Virtual Serial Port 106 and monitored by Application Software 104. Such commands may be advantageously logged by Application Software 104 and, based on predetermined characteristics contained in the data stream(s) associated with such commands, Application Software may determine that color-measurement data can be expected from Communications Application 102 in response. In an exemplary embodiment of the present disclosure, the logging of user commands is implemented by functionality associated with the Device Driver 105 or Application Software 104, and one or more of the logged user commands may function as a trigger for intercepting color-measurement data.

For example, a user command that a color-measuring instrument “take reading” may be automatically logged by programming associated with the Device Driver 105 or Application Software 104, and the logging of such measurement command may trigger the interception of the resulting color-measurement data generated by the color-measuring instrument. When the user directs the color-measuring instrument to make a measurement, the “measure” command will first be received by the VSP 106 and may function as a predetermined characteristic for initializing the Application Software 104 for intercepting spectral data gathered in response to the command. Thus, in exemplary embodiments of the present disclosure, the predetermined characteristic may be a command, instruction or other communication directed to the color-measuring instrument, e.g., a “take measurement” or “take reading” command. Other commands, such as the “calibrate” command, will not result in color-measurement/spectral data, and may thus be ignored.

Once a predetermined characteristic is detected in the data stream by Application Software 104, the command is communicated to the color-measuring instrument via Communications Application 102. Thereafter, color-measurement data is returned and Application Software 104 is advantageously programmed to automatically intercept such data stream based on the command previously identified at VSP 106 in route to the color-measuring instrument. Once intercepted, the color-measurement data may be further processed as described above, e.g., profiled based on one or more profiling software applications contained in Application Software 104.

To provide enhanced flexibility to users, methods and systems according to the subject disclosure may advantageously include one or more control options, whereby a user may activate interception of color-measurement/spectral data by providing or communicating a “log-on” command, and/or deactivate the interception functionality by providing or communicating a “quit” command. Similarly, enhanced flexibility may be provided according to the present disclosure by permitting users to activate/deactivate the processing of intercepted color-measurement data. Thus, for example, the user may activate/deactivate the profiling of color data intercepted according to the present disclosure.

In addition, data processing selection functionality may be provided according to the present disclosure, whereby a user may select from among alternative color data processing alternatives. Thus, as noted above, the disclosed method/system may advantageously provide a user with the ability to select from among a plurality of profiling software applications to be applied to intercepted color-measurement data, e.g., profiling software applications designed to profile color-measurement data based on alternative color-measurement standards.

Color-measurement data that is intercepted according to the present disclosure may be stored in local memory associated with the color-measurement instrument, e.g., on a hard drive or disk storage associated with the color measuring instrument. Such color-measurement data storage may include the intercepted color-measurement data before and after processing, i.e., before and after the color-measurement data is subjected to a profiling software application. Methods and systems of the subject disclosure may further facilitate the transmission of color-measurement/spectral data to a master color laboratory for analysis and/or validation, e.g., before or after profiling is undertaken.

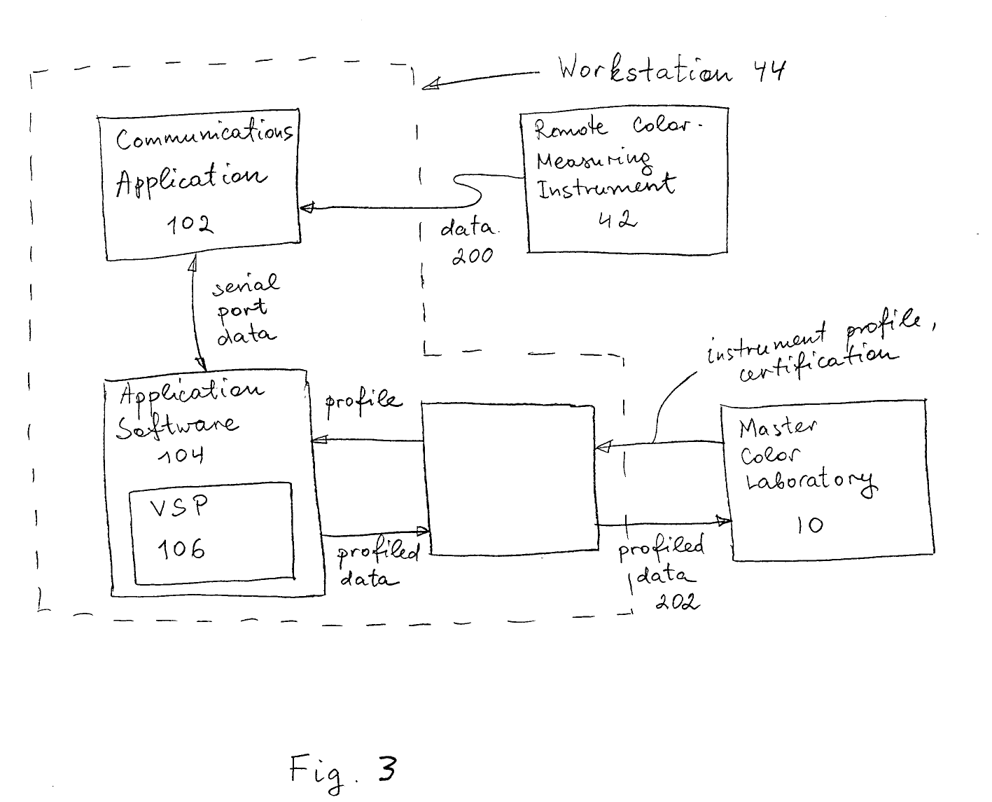

Referring to FIGS. 2 and 3, data communication systems are schematically depicted wherein color-measurement/spectral data 200 generated by color-measuring instrument 42 is transmitted to Communication Application 102 and intercepted by the Application Software 104, as described above. The intercepted data 200 may be manipulated at workstation 44 in a variety of ways, e.g., depending on a specific need. For example, in an exemplary embodiment of the present disclosure, a user may simply monitor the spectral data returned by the color-measuring instrument 42 in response to a “measure” command. In an alternative embodiment, the spectral data 200 generated by color-measuring instrument 42 and intercepted by Application Software 104 may be further processed, e.g., profiled. By profiling the color-measurement/spectral data 200, it is possible to achieve enhanced inter-instrument and/or intra-instrument agreement. In the data communication system of FIG. 2, profiled data 202 is advantageously transmitted to a master color laboratory, thereby facilitating instrument profiling and/or certification.

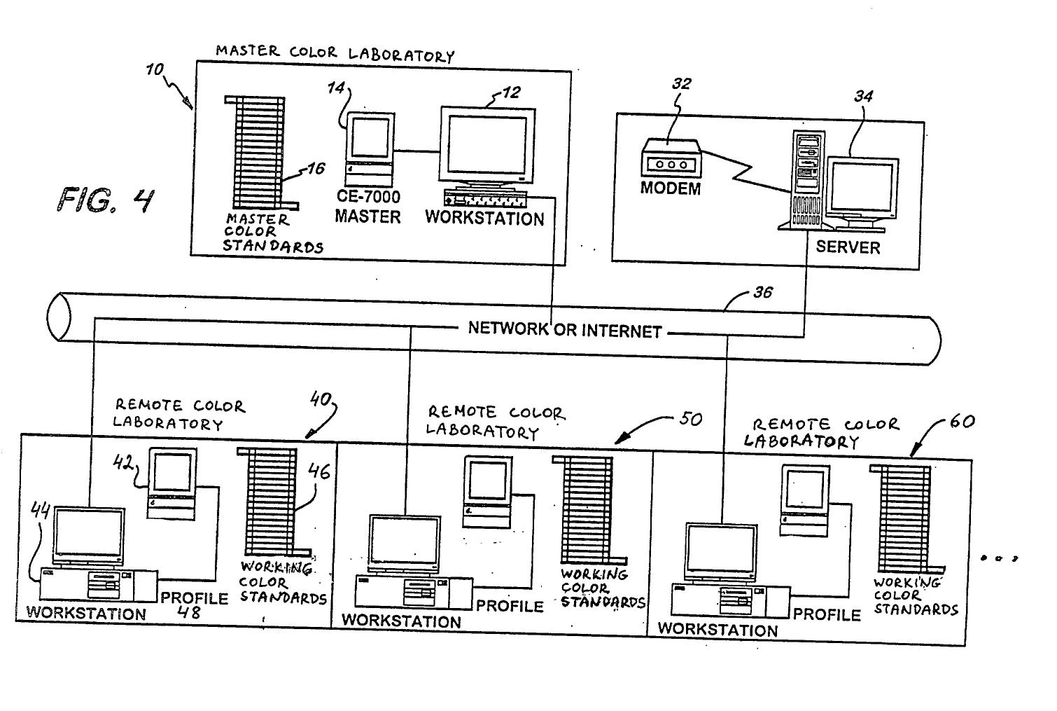

With reference to FIG. 4, a color management network 20 is schematically depicted. Network 20 includes a plurality of color-measuring instruments that employ the “intercept” functionality of the present disclosure. Remote color laboratories 40, 50, 60, etc. are connected to a master color laboratory 10 through a dedicated network 36, e.g., the Internet. Communications to server 34 are maintained/facilitated using modem 32. The remote color laboratory 40 includes a color-measuring instrument 42, such as a spectrophotometer, and a workstation 44, such as a computer.

As frequently occurs in the color management industry, the color-processing software associated with color-measuring instrument 42 of remote color laboratory 40 may be incompatible with color processing software operated at remote color laboratory 50 or 60, or in master color laboratory 10. In order to provide and/or enhance inter-instrument and intra-instrument agreement, the disclosed method/system can be used to intercept the color-measurement data transmitted by color-measuring instrument 42, and to profile such color-measurement data to achieve the desired agreement. For example, profiling of the color-measurement data may advantageously improve compatibility of that data with the data gathered by other instruments in or outside network 50. Thus, profile 48 may be applied to spectral data generated by instrument 42. At workstation 44, the spectral data is intercepted by Application Software 104 associated therewith utilizing VSP 106, as described above. Profiles 48 may be transmitted to the remote color-measurement laboratories on a periodic basis across network 36, and such profiles may be applied to color-measurements made by the remote color-measuring instruments to enhance inter- and/or intra-instrument agreement. Instrument profiles 48 may be stored at individual workstations or on a server 34, for access by remotely located Application Software 104, as needed.

While the invention has been described with respect to several specific, exemplary embodiments, those skilled in the art will readily appreciate that various modifications, changes, and enhancements may be made thereto without departing from the spirit or scope of the present disclosure. Accordingly, the present disclosure should be viewed as illustrative and not limiting of the presently claimed invention, as set forth in the appended claims.

What is claimed is:

1. A method for processing color-measurement data, comprising the steps of:
(a) detecting a predetermined characteristic in a data stream originating from a color-measuring instrument, said data stream containing color-measurement data;
(b) using the predetermined characteristic to locate the color-measurement data in the data stream; and
(c) intercepting the color-measurement data for further manipulation.

2. The method according to claim 1, wherein the predetermined characteristic is a specific length of a field in the data stream.

3. The method according to claim 1, wherein the predetermined characteristic is a specific field in the data stream.

4. The method according to claim 1, wherein the spectral data is intercepted utilizing a means for simulation of communications with a communications resource.

5. The method according to claim 4, wherein the communications resource is selected from the group consisting of a serial port, USB port, RF port, a wireless communication port, or a communications port supporting the IEEE 1394 standard.

6. The method according to claim 1, wherein the color-measurement data is intercepted utilizing a virtual serial port.

7. The method according to claim 6, wherein the virtual serial port includes a standard serial port interface to an operating system and an interface allowing software control of serial port functions.

8. The method according to claim 7, wherein the operating system is a Windows-based operating system.

9. The method according to claim 7, wherein the operating system is selected from the group consisting of a Macintosh-based operating system, a Linux-based operating system, and a Unix-based operating system.

10. The method according to claim 1, wherein the color-measuring instrument is a spectrophotometer.

11. The method according to claim 1, wherein the color-measurement data is spectral data.

12. The method according to claim 1, wherein the color-measurement data is calorimetric data.

13. The method according to claim 1, wherein step (a) is performed only after a “log-on” command is provided by a user.

14. The method according to claim 1, wherein no further steps are performed after a “quit” command is provided by a user.

15. The method according to claim 1, further comprising the step of:
(d) monitoring the color-measurement data.

16. The method according to claim 1, further comprising the step of:
(d) processing the color-measurement data.

17. The method according to claim 17, wherein processing the color-measurement data comprises profiling of said color-measurement data.

18. The method according to claim 1, further comprising the step of:
(d) transmitting the color-measurement data to a master color lab.

19. A method for processing color-measurement data, comprising the steps of:
(a) monitoring a data stream originating from an ancillary source;
(b) detecting a predetermined characteristic in the data stream originating from the ancillary source;
(c) using the predetermined characteristic to intercept color-measurement data transmitted by a color-measuring instrument in response to receipt of said data stream; and
(d) processing the color-measurement data.

20. The method according to claim 19, wherein the predetermined characteristic is a command for said color-measuring instrument.

21. The method according to claim 19, wherein the color-measurement data is intercepted utilizing a means for simulation of communications with a communication resource.

22. The method according to claim 21, wherein the communications resource is selected from the group consisting of a serial port, USB port, RF port, a wireless communication port, or a communications port supporting the IEEE 1394 standard.

23. The method according to claim 19, wherein the color-measurement data is intercepted utilizing a virtual serial port.

24. The method according to claim 19, wherein the color-measuring instrument is a spectrophotometer.

25. The method according to claim 19, wherein the color-measurement data is spectral data.

26. The method according to claim 19, wherein processing the color-measurement data includes profiling of said color-measurement data.

27. The method according to claim 19, wherein the color-measurement data is colorimetric data.

28. The method according to claim 19, wherein step (a) is performed only after a “log-on” command is provided by a user.

29. The method according to claim 19, wherein no further steps are performed after a “quit” command is provided by a user.

30. The method according to claim 19, further comprising the step of:
(e) transmitting the processed color-measurement data to a master color lab.

31. A method for processing color-measurement data, comprising the steps of:
(a) inputting a command using an input device associated with a color-measuring instrument;
(b) logging the command input to said input device based upon monitoring of communications at a virtual serial port;
(c) transmitting the command to the color-measuring instrument; and
if the command in step (c) directs the color-measuring instrument to make a measurement:
(d) causing the color-measuring instrument to make the measurement;
(e) detecting a predetermined characteristic in a data stream originating from the color-measuring instrument at the virtual serial port, said data stream containing color-measurement data;
(f) using the predetermined characteristic to locate the color-measurement data in the data stream;
(g) intercepting the color-measurement data utilizing the virtual serial port; and
(h) processing the color-measurement data.

32. The method according to claim 31, wherein processing the color-measurement data includes profiling of the color-measurement data.

33. The method according to claim 31, wherein the color-measuring instrument is a spectrophotometer.

34. The method according to claim 31, wherein the predetermined characteristic is a specific length of a field in the data stream.

35. The method according to claim 31, wherein the predetermined characteristic is a specific field in the data stream.

36. The method according to claim 31, further comprising preparing for intercepting the spectral data in response to logging the measurement command into the virtual serial port.

37. A system for enhancing inter-instrument and intra-instrument agreement, comprising:
a color measuring instrument that communicate with at least one computer processor, said at least one computer processor being configured to operate at least the following software applications:
(a) a color processing software application;
(b) a communications application for transmitting data streams related to operation of said color measuring instrument to at least one computer port;
(c) a virtual serial port that is configured to intercept data stream transmissions from said communications application; and
(d) application software that is programmed to monitor data stream transmissions intercepted by said virtual serial port and identify the presence of color-measurement data within said data stream transmissions.

38. The system according to claim 37, wherein said at least one computer processor comprises at least a first and a second processor, and wherein said software applications operate in part on said first processor and in part on said second processor.

39. The system according to claim 37, wherein said at least one computer processor is further configured to operate a color profiling software application.

40. The system according to claim 37, wherein said application software is programmed to identify the presence of color-measurement data based on a predetermined characteristic of said data stream transmissions.

41. The system according to claim 40, wherein said predetermined characteristic is selected from the group consisting of data stream transmission length, a field within the data stream transmission, an identifier within the data stream transmission, a command directed to said color-measuring instrument, and combinations thereof.

42. The system according to claim 37, wherein said at least one computer processor is further configured to operate a software application that permits operation of the application software to be controlled.
